(19) United States
(12) Patent Application Publication
(10) Pub. No.: US 2014/0230735 A1
(43) Pub. Date: Aug. 21, 2014

(54) MODULAR BEDS AND ENVIRONMENTS

(71) Applicant: Judith Lynn Coulter, Reno, NV (US)

(72) Inventor: Judith Lynn Coulter, Reno, NV (US)

(21) Appl. No.: 13/948,170

(22) Filed: Jul. 23, 2013

Related U.S. Application Data
(60) Provisional application No. 61/767,745, filed on Feb. 21, 2013.
(60) Provisional application No. 61/840,396, filed on Jun. 27, 2013.

(51) Int. Cl. A01K 1/035

(52) U.S. Cl. CPC A01K 1/0353
USPC 119/28.5

(57) ABSTRACT

Disclosed herein are representative embodiments of modular beds and environments. For example, in one example embodiment disclosed herein the pet bed comprises a bed frame having a central area surrounded by one or more side walls, a pillow sized to fit within the central area of the bed frame, and a blanket affixed to the pillow in a manner that allows at least a majority of the edges of the blanket to be free of the pillow. The denning bed may also be comprised of a single component bed wherein the pillow and blanket top are attached (not removable) from the bed frame. Also disclosed herein are embodiments of modular beds in which the bed frame comprises two or more cushioned components that can be removed from a fabric bed frame cover.

### CROSS REFERENCE TO RELATED APPLICATIONS

This application claims the benefit of U.S. Provisional Application No. 61/767,745, filed on Feb. 21, 2013, and entitled “MODULAR BEDS AND ENVIRONMENTS FOR PETS”, and the benefit of U.S. Provisional Application No. 61/840,396, filed on Jun. 27, 2013, and entitled “MODULAR BEDS AND ENVIRONMENTS FOR PETS”, both of which are hereby incorporated herein by reference.

### FIELD

This application relates to modular beds. For example, particular embodiments concern cushioned beds for pets.

### SUMMARY

Disclosed herein are representative embodiments of modular beds and environments. The disclosed beds and environments should not be construed as limiting in any way. Instead, the present disclosure is directed toward all novel and nonobvious features and aspects of the various disclosed embodiments, alone and in various combinations and subcombinations with one another.

One example embodiment disclosed herein is a modular bed system that comprises a bed frame comprising one or more side walls that surround a central cavity of the bed frame; a pillow sized to fit within the central cavity of the bed frame; and a blanket affixed to the pillow in a manner that allows a majority of the perimeter edges of the blanket to be free of the pillow. The bed frame and the pillow can have a square, rectangular, circular, or oval shape. In certain implementations, the blanket is oversized relative to the pillow such that the blanket covers the top surface of the pillow and has perimeter edges that extend beyond the perimeter edges of the pillow. In some implementations, the blanket has a generally circular shape whereas the pillow has either a square or rectangular shape. In certain implementations, the blanket is affixed to the pillow in a manner that allows a pet or small child using the bed to freely move and ruffle the blanket except at the points at which the blanket is affixed to the pillow. The blanket can also be formed from two or more fabric panels. In some implementations, the bed frame is formed from a fabric bed frame cover and a bed frame cushion located in the interior of the fabric bed frame cover, the bed frame cushion being removable from the bed frame cover. In such implementations, the bed frame cushion can be formed from two or more cushion components detachable from one another. For instance, the two or more cushion components can comprise a first bolster pillow and a second bolster pillow, the first bolster pillow and the second bolster pillow being bendable. Further, the ends of the first bolster pillow and the second bolster pillow can include an attachment mechanism such that the ends of the first bolster pillow are attachable to the ends of the second bolster when the first bolster pillow and the second bolster pillows are bent into the shape of the bed frame.

Another embodiment disclosed herein is a modular bed system that comprise a pillow having a top surface, a bottom surface, and one or more outward-facing side edges; and a blanket fastened to at least a central portion of the top surface of the pillow such that a majority or all of the edges of the blanket are free and unaffixed to the pillow, the blanket being sized to cover at least a majority of the top surface of the pillow and to have outward-facing edges that extend beyond at least some of the outward-facing side edges of the pillow. The modular bed system can further comprise a cushioned bed frame having a central area surrounded by one or more side walls, the central area being complementary in shape to the pillow and being sized to receive the pillow. In certain implementations, the one or more side walls have a top surface that extends around a perimeter of the cushioned bed frame, and the blanket is sized to at least partially cover the top surface of the side walls when the pillow is placed in the central area of the cushioned bed frame. In some implementations, the blanket is fastened to the pillow using an “X-shaped” or “plus-shaped” stitching pattern that is centered on the top surface of the pillow and thereby creates a plurality of ruffle regions. In certain implementations, the pillow has a square, rectangular, circular, or oval shape. In some implementations, the blanket is affixed to the pillow in a manner that allows a pet or small child using the bed to freely move the unaffixed portion of the blanket so that the blanket is not smooth. The blanket can also be formed from two or more fabric panels.

A further embodiment disclosed herein is a modular bed system that comprises a cushioned bed frame comprising one or more side walls that surround an central area, the cushioned bed frame having a bottom surface, the cushioned bed frame being formed from: (a) a fabric bed frame cover, the bed frame cover including a zipper assembly located on the bottom surface of the fabric bed frame cover, the zipper assembly being configured to provide selective access to an interior of the bed frame cover; and (b) a bed frame cushion positioned in the interior of the fabric bed frame cover, the bed frame cushion providing the structure of the one or more side walls, the bed frame cushion being removable from the fabric bed frame cover via the zipper assembly of the fabric bed frame cover. In certain implementations, the bed frame cushion is formed from two or more cushion components. For example, the two or more cushion components can consist of a first bolster pillow and a second bolster pillow. In some implementations, the first bolster pillow and the second bolster pillow are bendable and the ends of the first bolster pillow are attachable to the ends of the second bolster via an attachment mechanism when the first bolster pillow and the second bolster pillows are bent into the shape of the bed frame and the ends of the first bolster pillow are abutted to the ends of the second bolster pillow. In some implementations, the modular bed system further comprises a pillow having a shape that is complementary to the central area of the cushioned bed frame, the pillow having a top surface, a bottom surface, and one or more side edges; and a blanket fastened to at least a central portion of the top surface of the pillow such that all outward-facing edges of the blanket are free and unaffixed to the pillow, the blanket being sized to cover the top surface of the pillow and to have outward-facing edges that extend beyond the outward-facing side edges of the pillow. The blanket can also be formed from two or more blanket panels.

In another embodiment disclosed herein, the blanket is attached directly to the bed frame without having a separate pillow that fits within the bed frame. In such embodiments, the bed frame can be a cushioned bed frame and have a construction similar to that of the pillow. For example, the modular bed system can comprise a cushioned bed frame having a top surface and outward-facing side edges, and a blanket fastened to at least a central portion of the top surface of the bed frame such that a majority of the outward-facing edges of the blanket are free and unaffixed to the bed frame. In certain implementations, the blanket can be sized to cover at least a majority of the top surface of the pillow and to have outward-facing edges that extend beyond at least some of the outward-facing side edges of the bed frame. As with other embodiments disclosed herein, the blanket can be fastened to the cushioned bed frame using an “X-shaped” or “plus-shaped” stitching pattern that is centered on the top surface of the cushioned bed frame and thereby creates a plurality of ruffle regions. The cushioned bed frame can have a variety of shapes, such as square, rectangular, circular, or oval shape. Furthermore, the blanket can be affixed to the cushioned bed frame in a manner that allows a pet or small child using the bed to freely move the unaffixed portion of the blanket so that the blanket is not smooth. In certain implementations, the blanket can be formed from two or more fabric panels.

The foregoing and other aspects of the disclosed technology will become more apparent from the following detailed description, which proceeds with reference to the accompanying figures.

### BRIEF DESCRIPTION OF THE DRAWINGS

FIG. 1 is a top front perspective view of a first example embodiment for a bed that includes a pillow with attached blanket and a bed frame. In the particular embodiment shown in FIG. 1, the bed is configured for use by a pet. In FIG. 1, the pillow with attached blanket is shown separate from the bed frame and above the central enclosure of the bed frame in which the pillow with attached blanket can be inserted;

FIG. 2 is a top front perspective view of the example embodiment of FIG. 1. In FIG. 2, the pillow with attached blanket is inserted into the central enclosure of the bed frame.

FIG. 3 is a top view of the example embodiment of FIG. 1. In FIG. 3, the pillow with attached blanket is inserted into the central enclosure of the bed frame.

FIG. 4 is a front view of the example embodiment of FIG. 1. In FIG. 4, the pillow with attached blanket is inserted into the central enclosure of the bed frame. The left, right, and back views are the same as the front view.

FIG. 5 is a top front perspective view of the bed frame of the example embodiment of FIG. 1.

FIG. 6 is a bottom front perspective view of the bed frame of the example embodiment of FIG. 1.

FIG. 7 is a front view of the bed frame of the example embodiment of FIG. 1. The left, right, and back views are the same as the front view.

FIG. 8 is a bottom view of the bed frame of the example embodiment of FIG. 1.

FIG. 9 is a top view of the bed frame of the example embodiment of FIG. 1.

FIG. 10 is a top front perspective view of the pillow with attached blanket of the example embodiment of FIG. 1.

FIG. 11 is a bottom front perspective view of the pillow with attached blanket of the example embodiment of FIG. 1.

FIG. 12 is a front view of the pillow with attached blanket of the example embodiment of FIG. 1. The left, right, and back views are the same as the front view.

FIG. 13 is a bottom view of the pillow with attached blanket of the example embodiment of FIG. 1.

FIG. 14 is a top view of the pillow with attached blanket of the example embodiment of FIG. 1.

FIG. 15 is a top front perspective view of another embodiment for a bed that includes a pillow with attached blanket and a bed frame. In FIG. 15, the pillow with attached blanket is shown separate from the bed frame and above the central enclosure of the bed frame in which the pillow with attached blanket can be inserted.

FIG. 16 is a top front perspective view of the example embodiment of FIG. 15. In FIG. 16, the pillow with attached blanket is inserted into the central enclosure of the bed frame.

FIG. 17 is a top view of the example embodiment of FIG. 15. In FIG. 17, the pillow with attached blanket is inserted into the central enclosure of the bed frame.

FIG. 18 is a front view of the example embodiment of FIG. 15. In FIG. 18, the pillow with attached blanket is inserted into the central enclosure of the bed frame. The back view is the same as the front view.

FIG. 19 is a left side view of the example embodiment of FIG. 15. In FIG. 19, the pillow with attached blanket is inserted into the central enclosure of the bed frame. The right side view is the same as the left side view.

FIG. 20 is a top front perspective view of the bed frame of the example embodiment of FIG. 15.

FIG. 21 is a bottom front perspective view of the bed frame of the example embodiment of FIG. 15 showing a zipper assembly in an unzipped state to reveal an interior channel in the bed frame.

FIG. 22 is a top view of the bed frame of the example embodiment of FIG. 15.

FIG. 23 is a bottom view of the bed frame of the example embodiment of FIG. 15 showing the zipper assembly in a zipped state.

FIG. 24 is a bottom view of the bed frame of the example embodiment of FIG. 15 showing the zipper assembly in an unzipped state to reveal an interior channel in the bed frame.

FIG. 25 is a top front perspective view of the pillow with attached blanket of the example embodiment of FIG. 15.

FIG. 26 is a top view of the pillow with attached blanket of the example embodiment of FIG. 15.

FIG. 27 is a bottom view of the pillow with attached blanket of the example embodiment of FIG. 15.

FIG. 28 is a front view of the pillow with attached blanket of the example embodiment of FIG. 15. The back view is the same as the front view.

FIG. 29 is a left side view of the pillow with attached blanket of the example embodiment of FIG. 15. The right side view is the same as the left side view.

FIG. 30 is a top front perspective view of a bolster pillow formed from two bolster pillow components. The bolster pillow is insertable into the channel of the bed frame of the example embodiment in FIG. 15.

FIG. 31 is a front view of a first bolster pillow component of the example embodiment in FIG. 15

FIG. 32 is a left end view of the first bolster pillow component of the example embodiment in FIG. 15.

FIG. 33 is a right end view of the first pillow component of the example embodiment in FIG. 15.

FIG. 34 is a front view of a second bolster pillow component of the example embodiment in FIG. 15

FIG. 35 is a left end view of the second bolster pillow component of the example embodiment in FIG. 15.

FIG. 36 is a right end view of the second pillow component of the example embodiment in FIG. 15.

FIG. 37 is a top view of the bolster pillow formed from two bolster pillow components.

FIG. 38 is a cross-sectional side view of the example embodiment in FIG. 15.

FIG. 39 is a top view of the pillow with attached blanket of FIG. 1 further illustrating a “plus-shaped” stitching pattern for attaching the blanket to the pillow.

FIG. 40 is a top view of the pillow with attached blanket of FIG. 1 further illustrating an “X-shaped” stitching pattern for attaching the blanket to the pillow.

FIG. 41 is a top view of the pillow with attached blanket of FIG. 1 further illustrating a central stitching pattern for attaching the blanket to the pillow.

FIG. 42 is a perspective view of an example bed frame together with a canopy structure.

FIGS. 43 and 44 are a series of images showing pets exhibiting their nesting instinct and arranging the blanket of the pet bed of FIG. 1 into a desired arrangement and lying in the bed.

FIG. 45 is a bottom front perspective view of the bed frame of the example embodiment of FIG. 15 showing a zipper assembly in an unzipped state to reveal an interior channel in the bed frame. Also shown in FIG. 45 is the bolster pillow for insertion into the interior channel.

FIG. 46 is a top view of an example pillow quadrant with blanket.

FIG. 47 is a top view of an example pillow quadrant before the blanket is attached.

FIG. 48 is a top view of an example blanket quadrant before it is attached to the pillow quadrant.

FIG. 49 is a top view of another example blanket quadrant before it is attached to the pillow quadrant.

### DETAILED DESCRIPTION

Disclosed herein are representative embodiments of modular beds and environments (e.g., for use by pets or other users, such as newborns, infants, or other small children). The disclosed beds and environments should not be construed as limiting in any way. Instead, the present disclosure is directed toward all novel and nonobvious features and aspects of the various disclosed embodiments, alone and in various combinations and subcombinations with one another. Furthermore, any features or aspects of the disclosed pet beds and environments can be used alone or in various combinations and subcombinations with one another. The disclosed beds and environments are not limited to any specific aspect or feature or combination thereof, nor do the disclosed beds and environments require that any one or more specific advantages be present or problems be solved. Furthermore, as used herein, the term “and/or” means any one item or combination of items in the phrase.

Embodiments of the disclosed technology comprise a modular bed or environment for pets (e.g., cats, dogs, or other household pets) or other users (e.g., newborns, infants, or other small children). For ease of presentation, this disclosure will generally refer to a modular bed and/or environment for pets, though it is to be understood that the disclosed technology can be adapted for other users as well (e.g., small children). In certain embodiments, the modular bed comprises a cushioned bed frame with a removable pillow. In particular implementations, a blanket is affixed to the pillow in a manner that allows the blanket to be ruffled or otherwise manipulated by a pet into a desired state. For example, and as more fully explained below, the blanket can be affixed to the pillow in a manner that allows at least a majority of the edges of the blanket to be free of pillow.

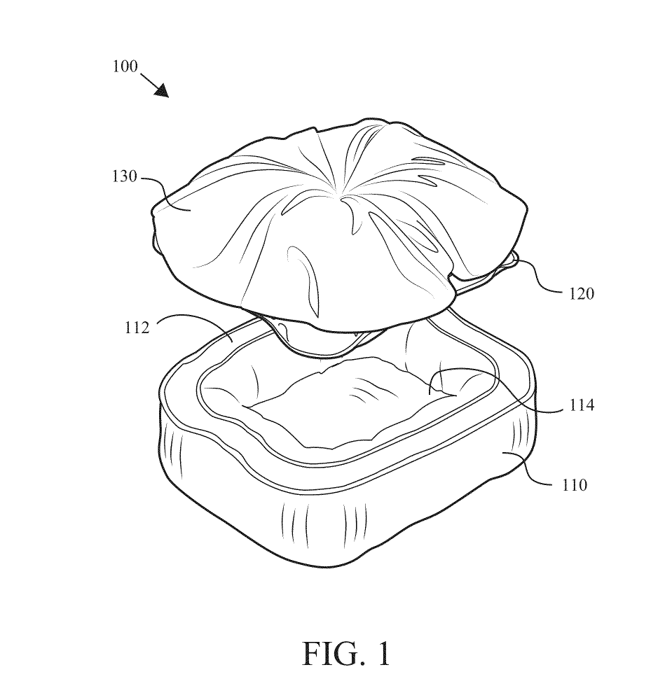

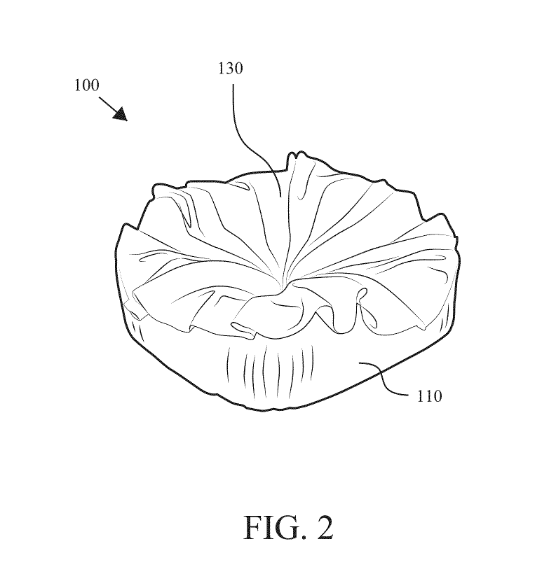

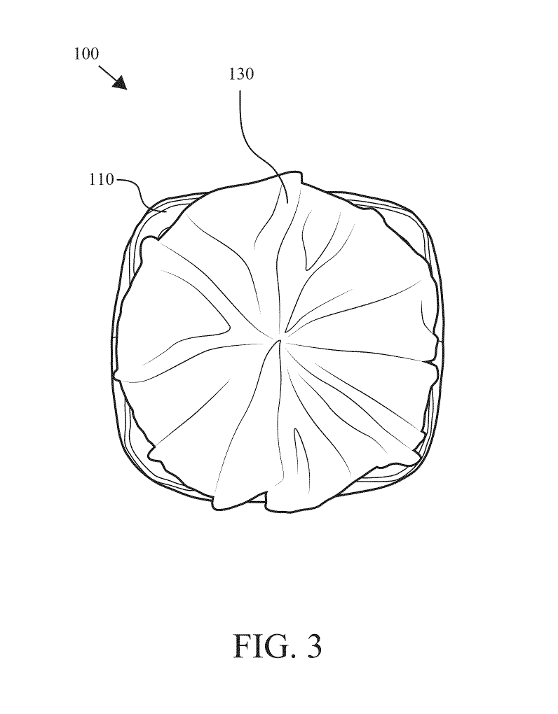

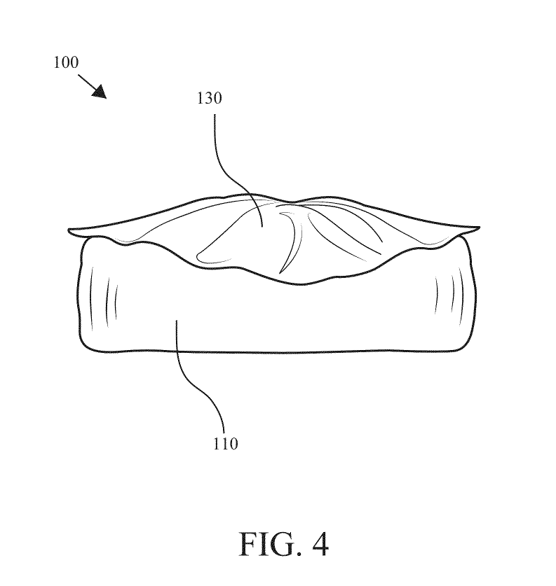

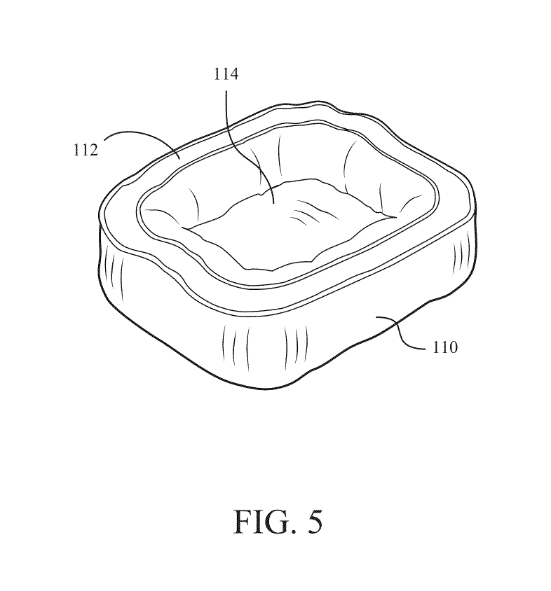

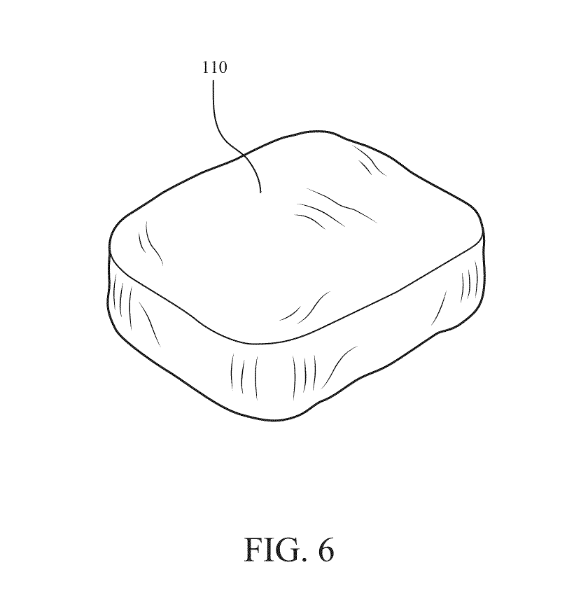

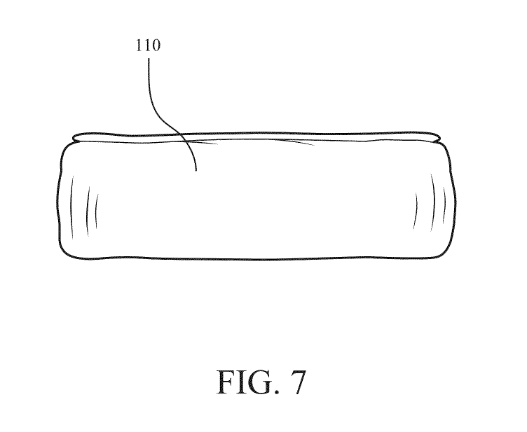

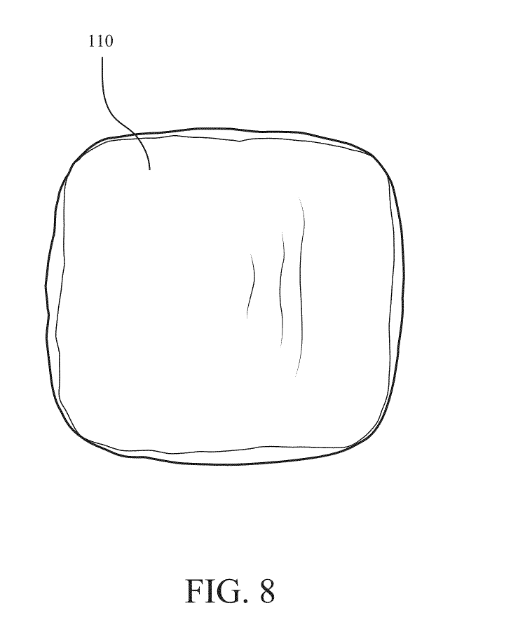

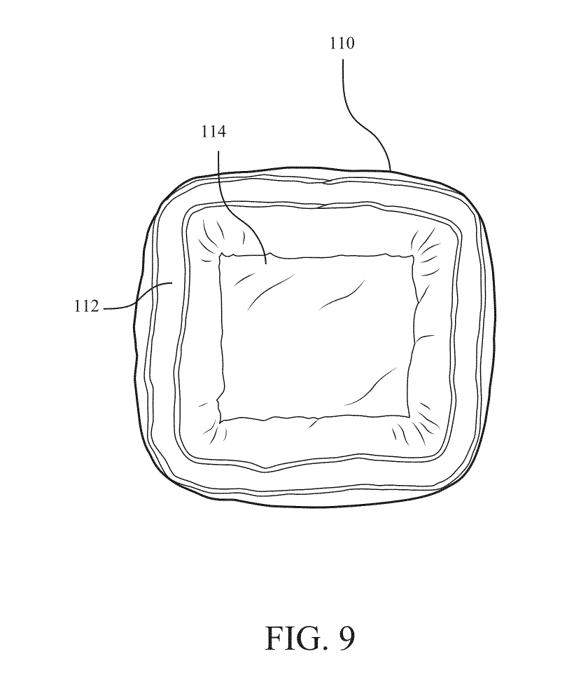

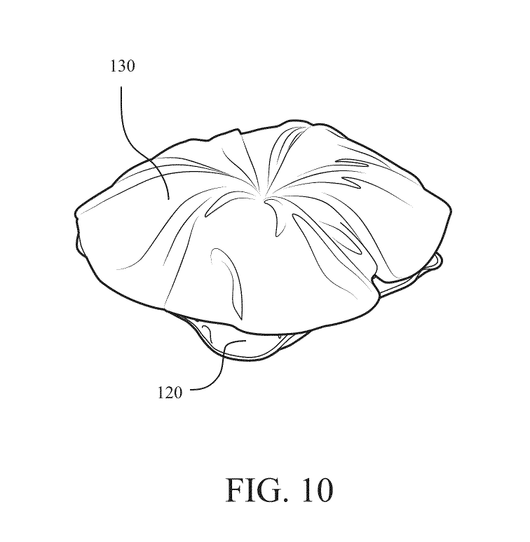

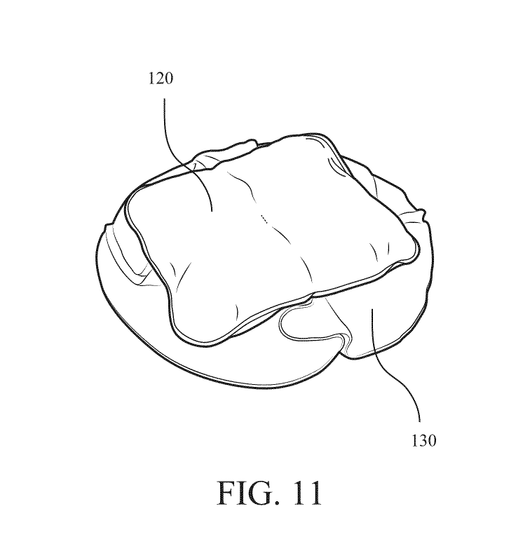

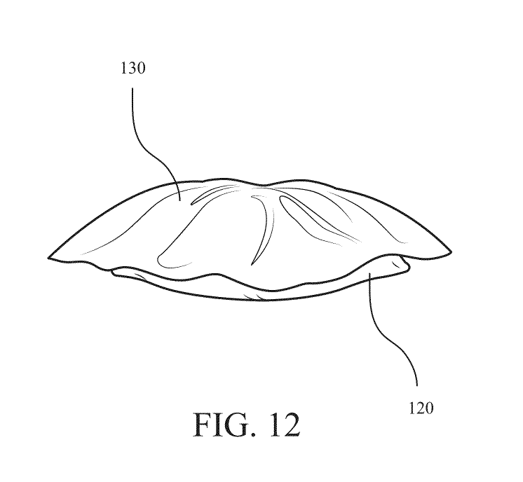

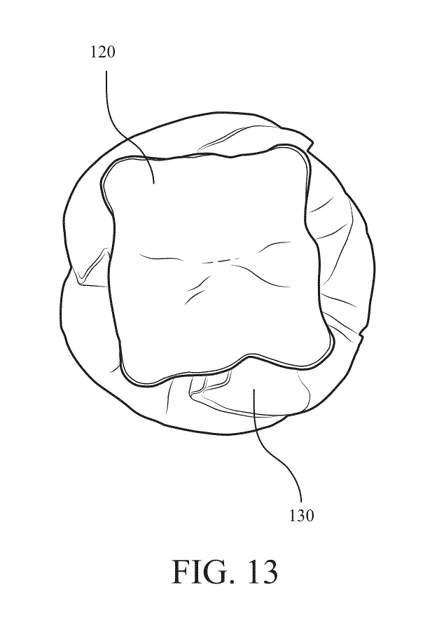

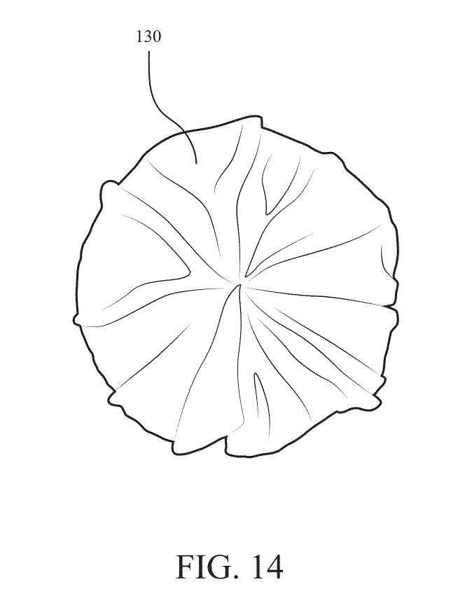

FIGS. 1-14 illustrate a first example modular bed 100 comprising a cushioned bed frame 110 and a removable pillow 120. The bed frame 110 can be a soft bed frame formed from a soft foam, memory foam, a fabric cover stuffed with a suitable filler (such as cotton, down, polyester, or other such material), a fabric cover enclosing a removable insert (such as a pillow or insert formed from a soft foam, memory foam, or filled with cotton, down, polyester, or other such fiber), or any other suitable material. Similarly, the removable pillow 120 can be formed at least in part from a soft foam, memory foam, a fabric cover stuffed with a suitable filler (such as cotton, down, polyester, or other such material), or any other suitable material).

The bed frame 110 can have a variety of sizes and shapes (e.g., round, oval, rectangular, triangular, or any other shape). In the illustrated embodiment, the bed frame 110 is square and has side walls (such as side wall 112) that define a square-shaped interior enclosure (or cavity) 114 into which the removable pillow 120 can be fit. In the illustrated embodiment, the removable pillow 120 is sized to fit tightly within the interior cavity of the bed frame 110, thereby helping to secure the pillow 120 within the bed frame 110 through a friction fit. In the illustrated embodiment, the side walls (such as side wall 112) completely surround the edges of the pillow 120, although in other embodiments, the bed frame can only partially enclose the pillow 120 (e.g., by surrounding a majority of the pillow, such as by surrounding three sides of the pillow).

Furthermore, in certain embodiments, the shape of the bed frame 110 and the pillow 120 is selected to have one or more corners (e.g., a square shape having four corners) so as to hinder rotation of the pillow 120 within the bed frame 110.

In certain embodiments, the pillow 120 includes an attached blanket 130. In particular, a blanket 130 can be affixed to the top of the pillow 120. As more fully explained below, the blanket 130 can be attached to the top of pillow 120 at one or more locations. Desirably, the blanket 130 is attached to the pillow 120 in a manner that allows the blanket 130 to maintain its general orientation on the pillow 120 and to maintain the coverage over the pillow 120.

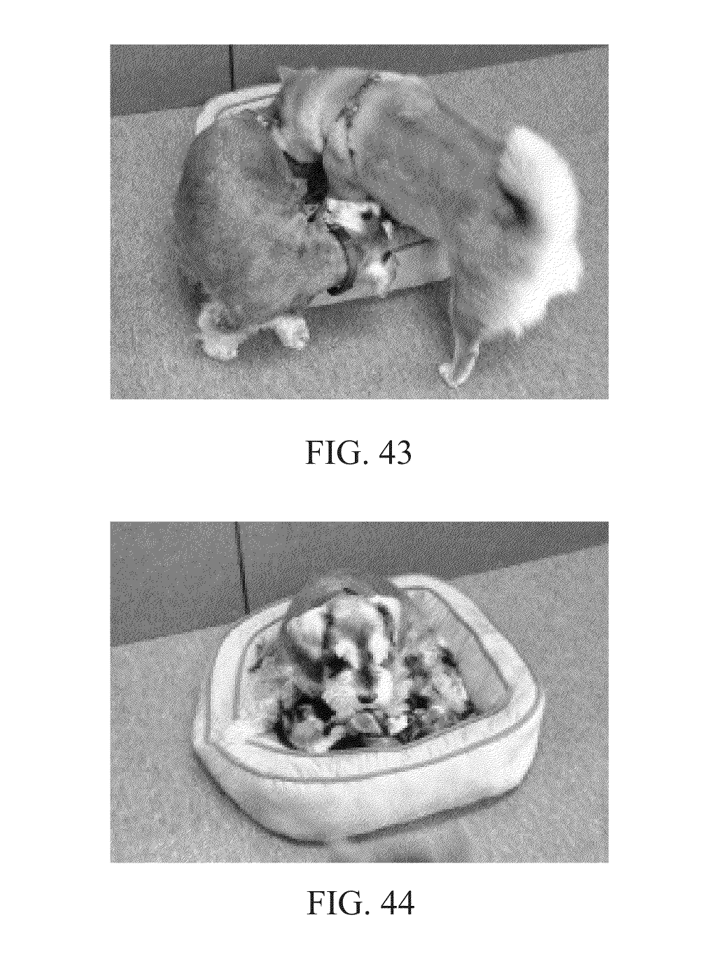

Furthermore, in certain embodiments, the blanket 130 is sized and configured so that it is not drawn taught over the pillow 120, but instead is sized to have excess material creating one or more ruffles or folds in the blanket 130 on the top of the pillow 120. The ruffles (or folds) of the blanket 130 provide surfaces that a pet can arrange before lying down. Such “denning” or “nesting” behavior (where a pet paws at the bedding material and arranges into a den or nest) is instinctive in many pets. Accordingly, it is desirable to provide a bed that accommodates this instinct and allows for the pet to sleep more comfortably. Example images of dogs exhibiting this behavior are shown, for example, in FIGS. 43 and 44.

In the illustrated embodiment, the blanket 130 is designed to accommodate a pet's denning instinct and to allow the pet arrange the blanket 130 into a comfortable position without the blanket becoming uncentered from the pillow 120. For example, the blanket 130 is a “ruffle” blanket securely attached to a top surface of the pillow 120.

In particular embodiments, the blanket is large enough so that the blanket's perimeter edges (the blanket's outward-facing side edges) cover at least a majority of the top surface of the pillow (e.g., to cover the entire top surface of the pillow) and extend beyond at least some of the outward-facing side edges of the pillow (e.g., to extend beyond all the outward-facing side edges of the pillow). In other words, the blanket is oversized relative to the pillow such that the area of the top surface of the blanket can be larger than the top surface of the pillow. The blanket 130 can have any shape, but in illustrated embodiment is a circular blanket, and thereby resembles a natural nest instinctively recognized by the pet.

To accommodate and promote the pet's denning instinct, in the illustrated embodiment, the blanket 130 is attached to the pillow in a manner that allows pet to freely move and ruffle the blanket except at the points where the blanket is affixed to the pillow. For example, the blanket can be affixed to the pillow in a manner that allows a majority of the perimeter edges of the blanket to be free of the pillow. For instance, greater than 50%, greater than 75%, greater than 90%, or all of the perimeter edges of the blanket can be free of the pillow.

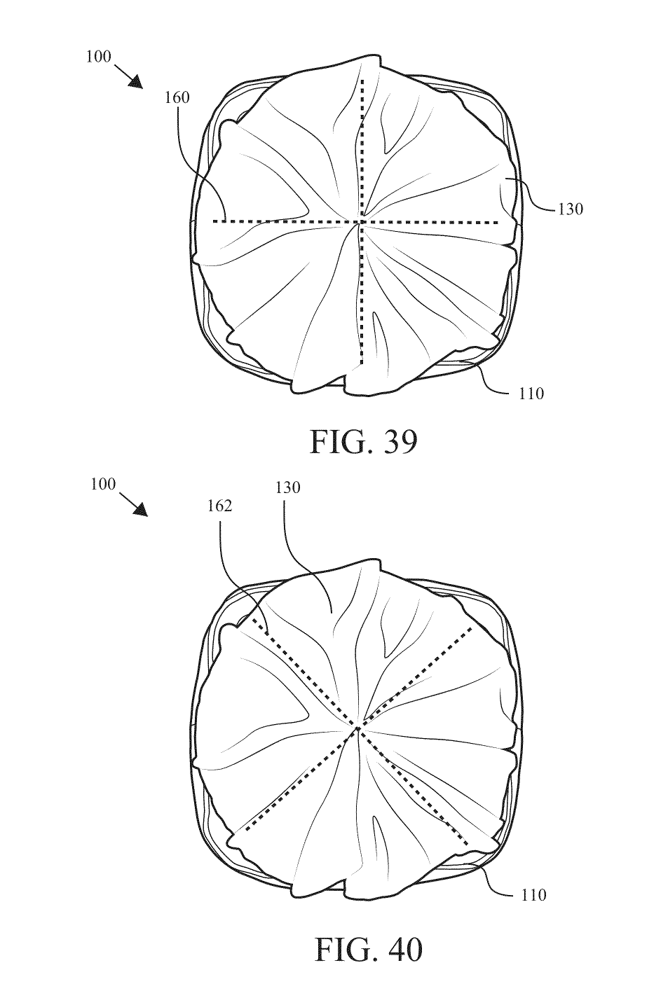

In certain exemplary implementations, the blanket 130 is secured to the top surface of the pillow 120 in a manner that creates four quadrants. For example, as shown in FIG. 39, the blanket 130 can be attached to the pillow 120 through stitching 160 that forms a “plus-shaped” pattern (a first line of stitching extends from the center of a pillow edge to the center of the opposite pillow edge, a second line of stitching extends from the center of an adjacent pillow edge to the center of the opposite pillow edge, the two lines of stitching generally forming the shape of a plus sign and intersecting at or near the center of the top surface of the pillow).

Alternatively, and as shown in FIG. 40, the blanket 130 can be attached to the pillow 120 through stitching 162 that forms an “X-shaped” pattern (a first line of stitching extends from a corner of the pillow to an opposite corner of the pillow, a second line of stitching extends from an adjacent corner of the pillow to an opposite corner of the pillow, the two lines of stitching generally forming the shape of an “X” and intersecting at or near the center of the top surface of the pillow).

Both of the stitching patterns in FIGS. 39 and 40 form four symmetrical quadrants. This type of stitching pattern secures the blanket 130 to the pillow 120 but creates multiple “ruffle” regions (e.g., four regions) of excess material that the pet can paw at and arrange. Further, the symmetrical stitching illustrated in FIGS. 39-40 also prevent the blanket 130 from twisting about the pillow 120 as the pet paws and arranges the blanket 130 for comfortable rest or sleep.

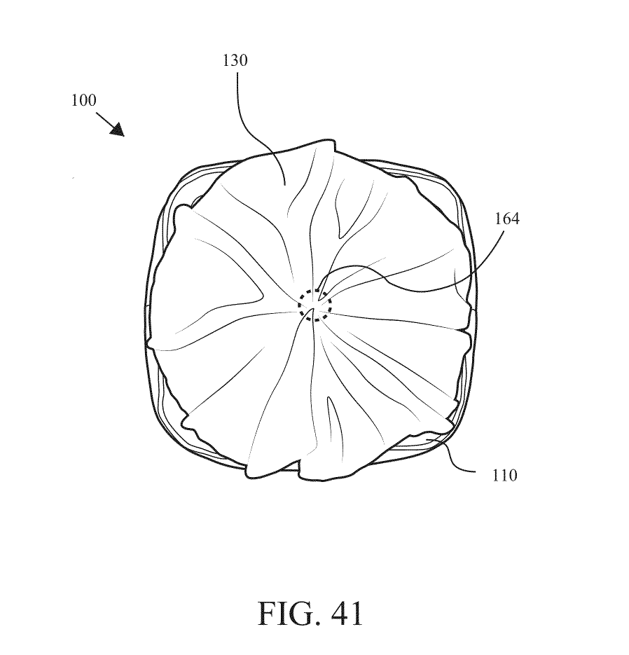

The stitching pattern can vary from implementation to implementation. Consequently, the number of “ruffle” regions can also vary. For example, the stitching can be arranged so that two or more “ruffle” regions are created, or so that the blanket is secured only at a central point or area on the pillow, thereby creating a radial ruffle region. In FIG. 41, for instance, circular stitching 164 affixes the center of the blanket 130 to the pillow 120. It should be noted that the stitching need not be symmetrical, but instead can form any pattern and have any number of contact points.

Still further, in certain embodiments, the blanket is formed from multiple components (e.g., fabric panels) that are individually stitched to the pillow. For example, in one exemplary embodiment, the blanket 130 shown in FIGS. 39 and 40 is formed from four separate blanket panels that are stitched to the pillow to form the “X-shaped” or “plus-shaped” patterns shown in FIGS. 39 and 40. In other words, the four ruffle regions (or quadrants) shown in FIGS. 39 and 40 are each formed from separate blanket panels stitched to the pillow in a manner that allows the outward-facing perimeter edges of the blanket to remain free of the pillow and to create excess material and folds that allow the pet to ruffle the blanket portions as described above.

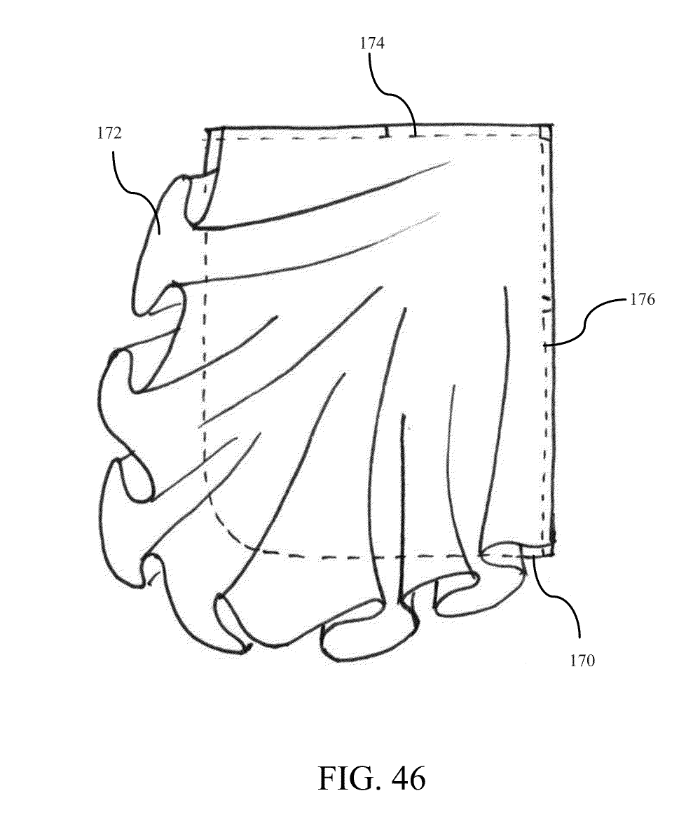

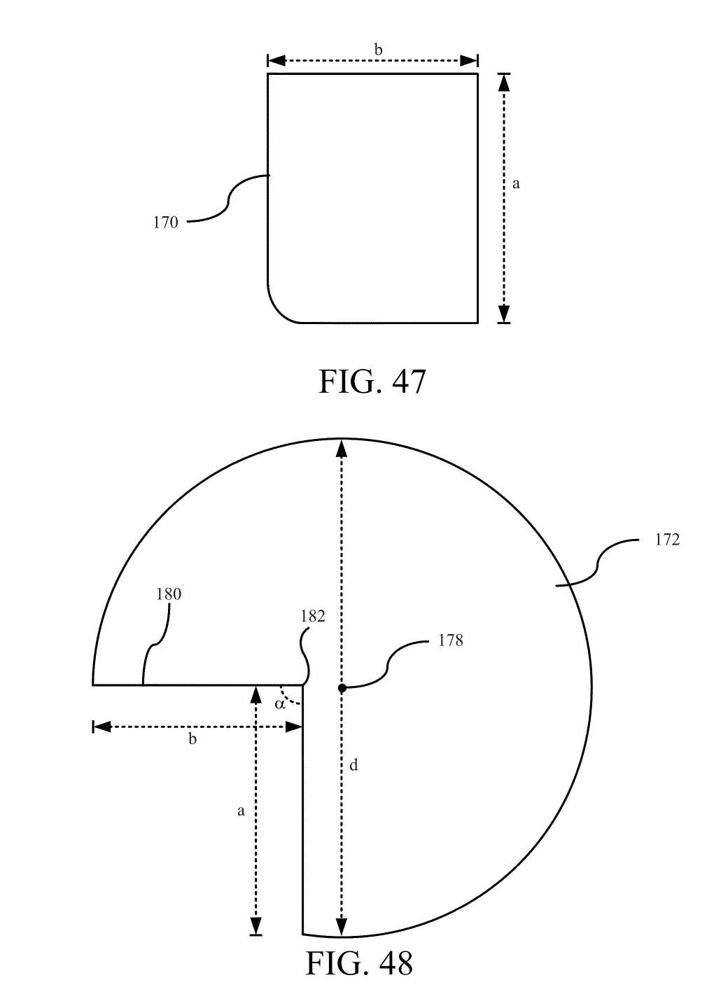

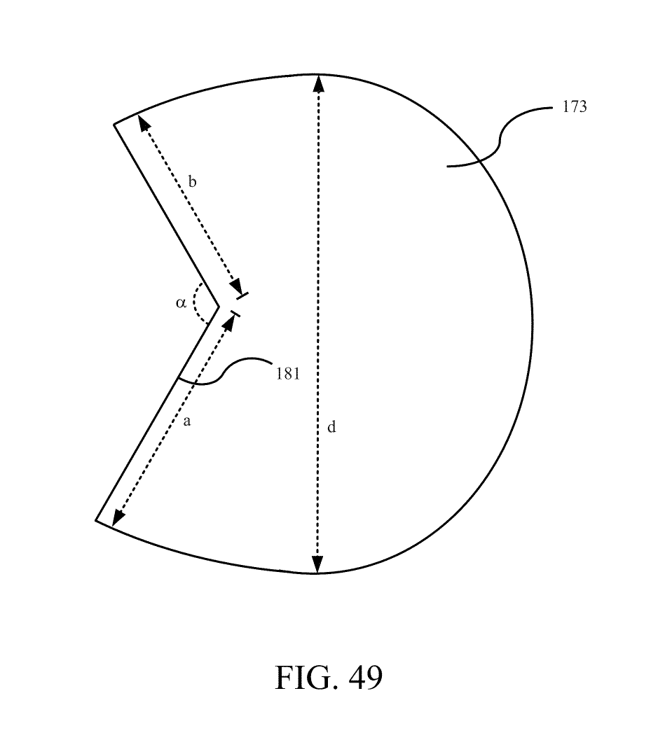

FIGS. 46-49 illustrate embodiments in which the blanket is formed from multiple fabric panels. In particular, FIG. 46 is a top view of a pillow quadrant 170 to which a blanket quadrant 172 (or blanket panel) is attached along lines 174, 176. FIG. 47 is a top view of the pillow quadrant 170 without the attached blanket quadrant 172 and without showing the remainder of the pillow. The dimensions of the pillow quadrant 170 are shown as length dimension “a” and width dimension “b” in FIG. 47. FIG. 48 is a top view of the blanket quadrant 172 before it is attached to the pillow quadrant and spread out in a flat state. As can be seen in FIG. 48, the blanket quadrant 172 of this embodiment has a generally circular shape except for a cutout 180 that is sized to match the length and width of the pillow quadrant (shown again as dimensions “a” and “b” in FIG. 47). The diameter of the blanket quadrant 172 can vary but in certain implementations is sized to be larger than the pillow quadrant 170 (e.g., to have a diameter larger than either or both of the length and width of the pillow quadrant (by a ratio of 1.1:1 or larger; 1.5:1 or larger, 2:1 or larger; 2.5:1 or larger; or 3:1 or larger)). For example, and referring to FIGS. 47 and 48, the diameter “d” of the unattached blanket quadrant 172 is approximately twice as long as the length “a” of the pillow quadrant (a ratio of approximately 2:1) and approximately 2.3 times as long as the length “b” of the pillow quadrant. Furthermore, because the blanket quadrant 172 can have a diameter more than twice the size of the length or height of the pillow quadrant 170, the cutout 180 may have an apex 182 that is not co-located with a center 178 of the blanket quadrant 172 (as illustrated in FIG. 48). Additionally, the angle α of the cutout 180 is shown as being 90° but can be greater than 90°. For example, FIG. 49 is a top view of another blanket quadrant 173 before it is attached to the pillow quadrant and spread out in a flat state. The blanket quadrant 173 has a cutout 181 with an angle α greater than 90°. Furthermore, the overall shape of the blanket quadrant is more elliptical and oblong than blanket quadrant 172. One skilled in the art will appreciate that when the oversized blanket quadrant 172 or 173 is attached to the pillow quadrant 170 along the lines 174, 176 and folded back over the top surface of the pillow quadrant 170, the blanket quadrant 172 or 173 will form one or more ruffles or folds of excess material as shown in FIG. 46. When all four blanket quadrants are attached to the pillow quadrant, a complete blanket will be formed as shown, for example, in FIG. 39.

The dimensions and size of the blanket quadrant can vary from embodiment to embodiment. For example, in one particular embodiment, the blanket quadrant has a circumference of or about 59.775″, a diameter of or about 34″, a line “b” length of or about 10.5″, a line “a” length of or about 11.75″, and an angle α of or about 134°. In such embodiments, the pillow can be 19″×21″ and the bed frame can be 21.5″×24″×8″ deep. In another particular embodiment, the blanket quadrant has a circumference of or about 83.079″, a diameter of or about 25″, a line “b” length of or about 11.075″, a line “a” length of or about 14.861″, and angle α of or about 126.7°. In such embodiments, the pillow can be 23″×30″ and the bed frame can be 26″×34″×10″ deep. In yet another particular embodiment, the blanket quadrant has a circumference of or about 90.769″, a diameter of 56″, a line “b” length of or about 14.861″, a line “a” length of or about 20.884″, and an angle α of or about 168.454°. In such embodiments, the pillow can be 27.5″×19″ and the bed frame can be 31.5″×45″×12″ deep.

Additionally, instead of being attached to the pillow 120 through stitching, the blanket 130 can be attached to the pillow at the desired attachment points using any of a variety of mechanisms providing a removable attachment (e.g., buttons, ties, buckles, snaps, knots, Velcro, zippers, or any other mechanism providing a selective attachment).

As noted, the bed frame 110, pillow 120, and attached blanket 130 provide animals with the ability to “den” or “nest.” For many animals, this activity is instinctive. Embodiments of the disclosed technology therefore satisfy the animal's natural desire to “fluff” their bedding as well as mark their territory and sleeping location.

Embodiments of the disclosed technology can also provide an aesthetically pleasing look for the pet owner. For instance, the blanket can have a wide variety of patterns or images that provide the modular bed with an attractive look.

In certain embodiments, one or more of the components of the modular bed are washable. For example, the cover of the bed frame 110 and/or pillow 120 can be removed and washed. Further, in certain embodiments, the blanket 130 can be detached from the pillow 120 and subsequently washed or replaced.

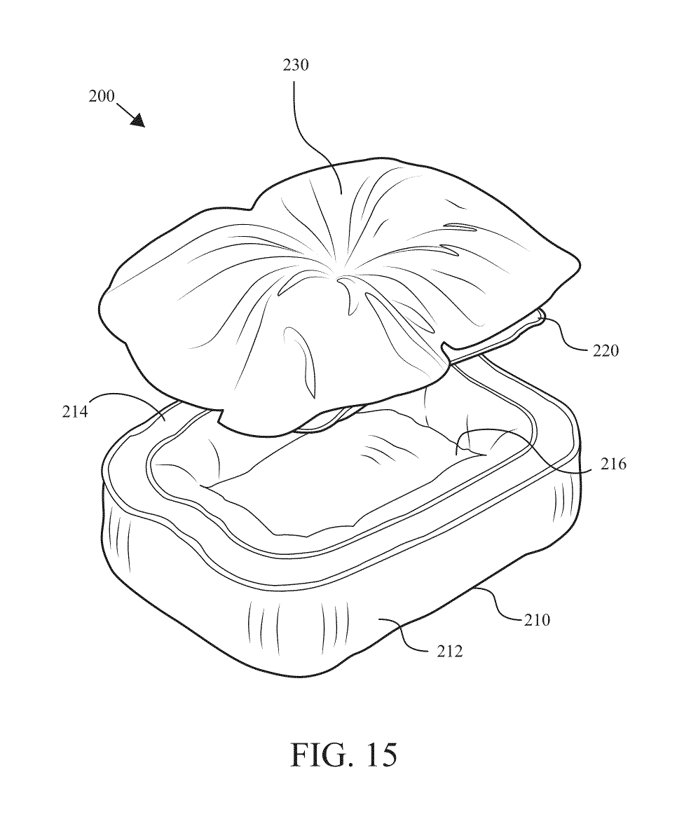

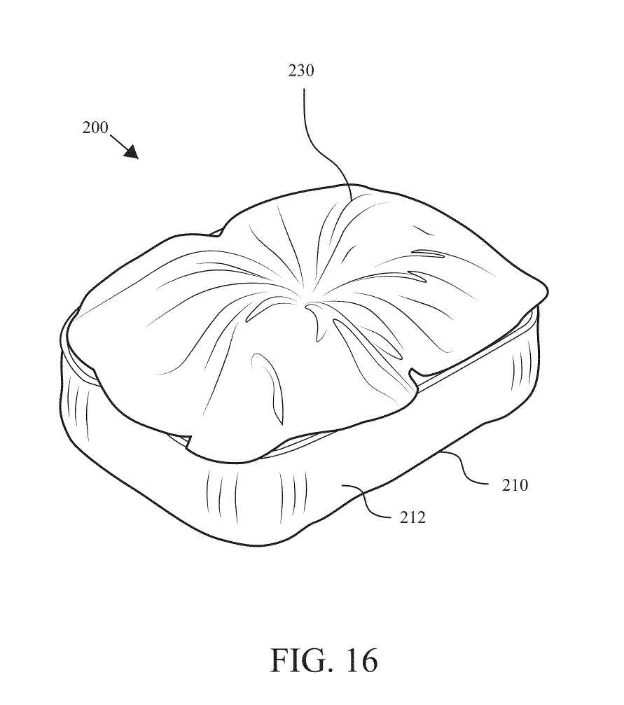

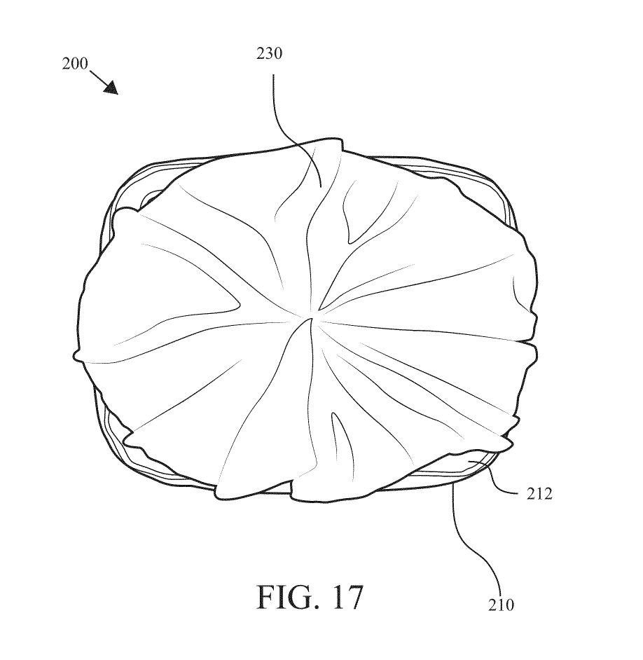

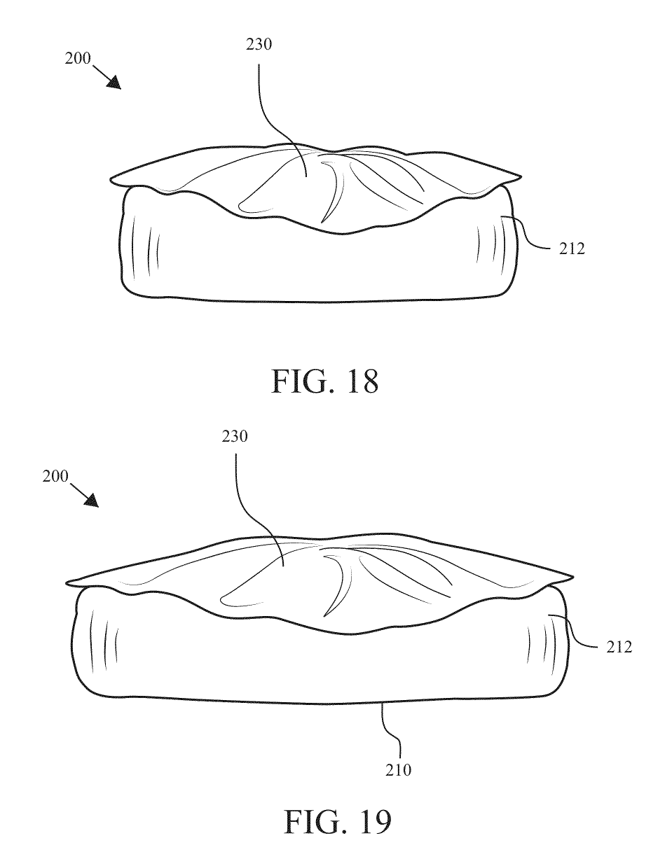

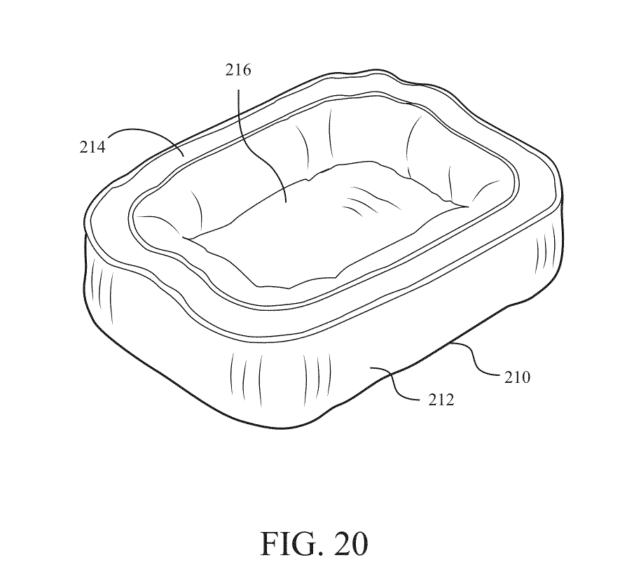

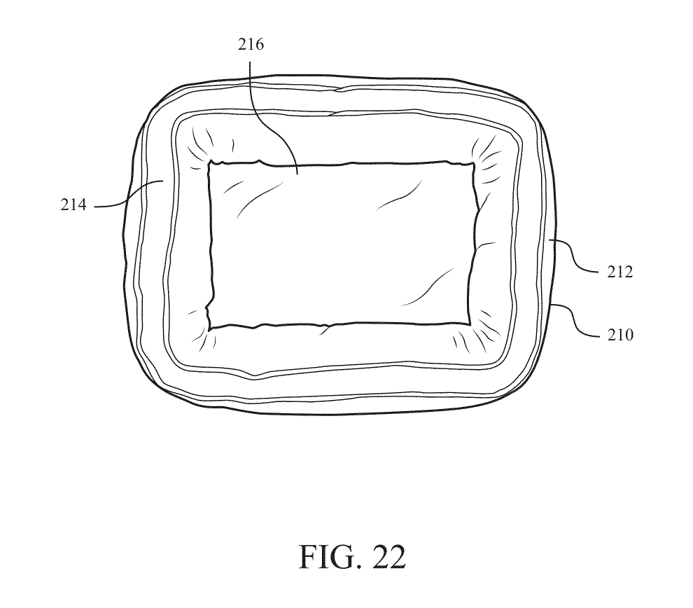

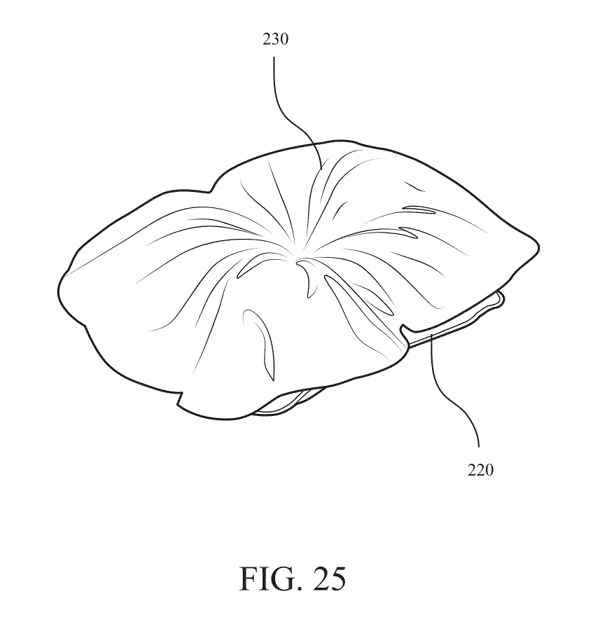

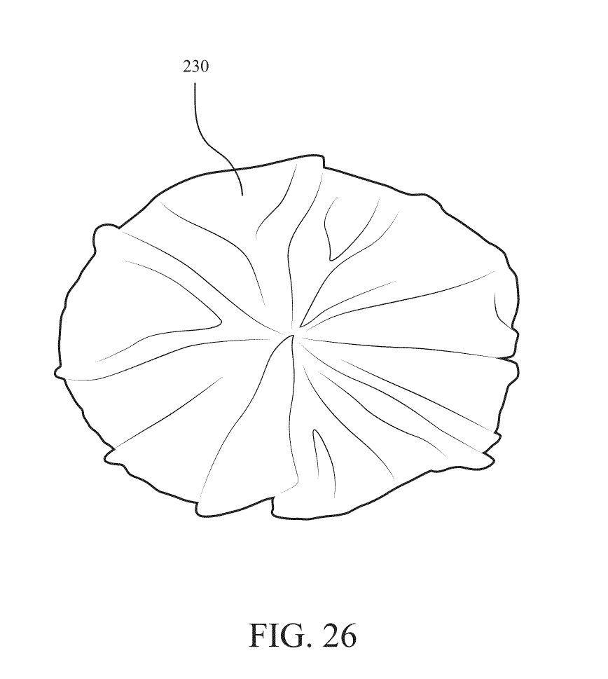

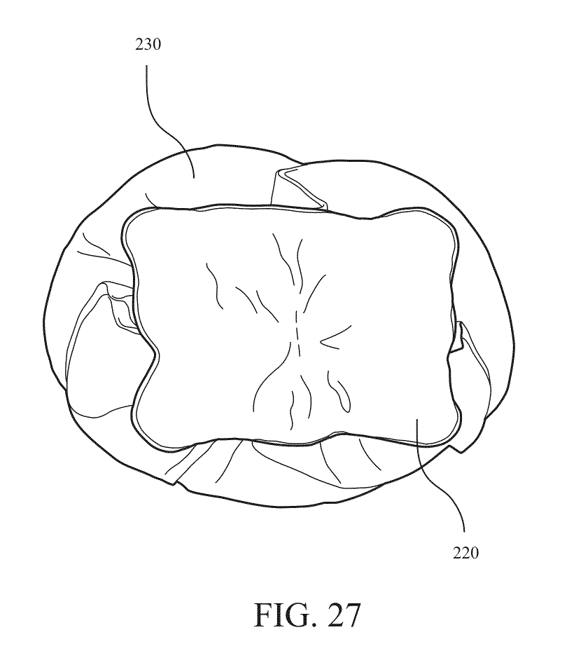

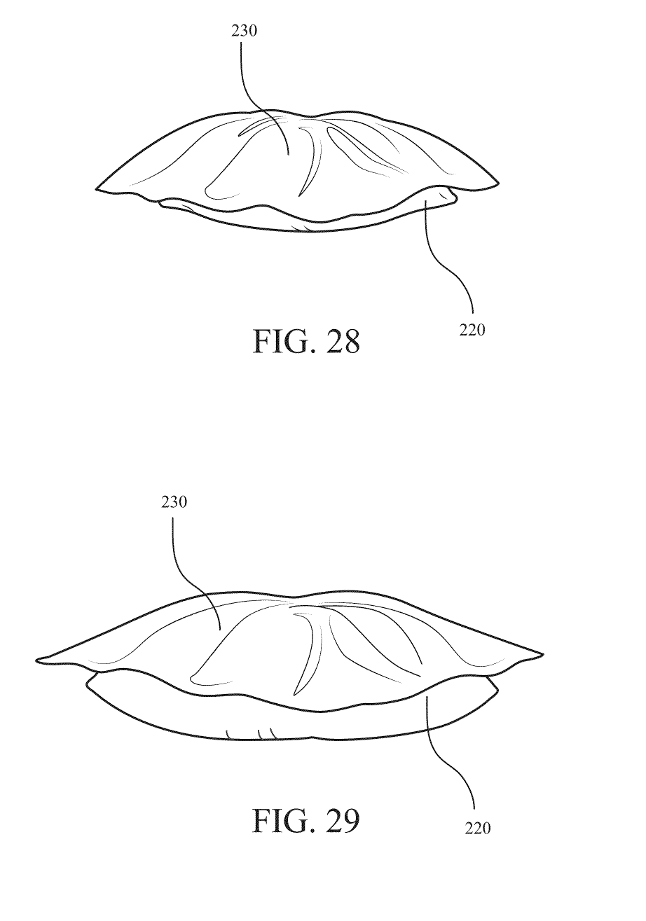

In this regard, FIGS. 15-31 illustrate an embodiment of a pet bed 200 in which the bed frame 210 of the pet bed comprises a fabric bed frame cover 212 that encloses a removable bed frame cushion. Thus, the fabric bed frame cover 212 can be washed as needed. Like the embodiment illustrated in FIGS. 1-14, the bed frame 210 also comprises one or more side walls (such as side wall 214) that define a central enclosure (cavity) 216 into which a pillow 220 with attached blanket 230 can be inserted. Moreover, in the illustrated embodiment, the pet bed 200 has a general rectangular shape and is sized to fit medium or large pets (e.g., medium or large dogs). Unless stated otherwise, any of the aspects of the pet bed 200 can be the same as the pet bed 100 and the various embodiments described above, and thus need not be repeated with respect to the pet bed 200. For example, except for the shape, the pillow 220 with attached blanket 230 is substantially identical to any of the pillow and blanket combinations described above.

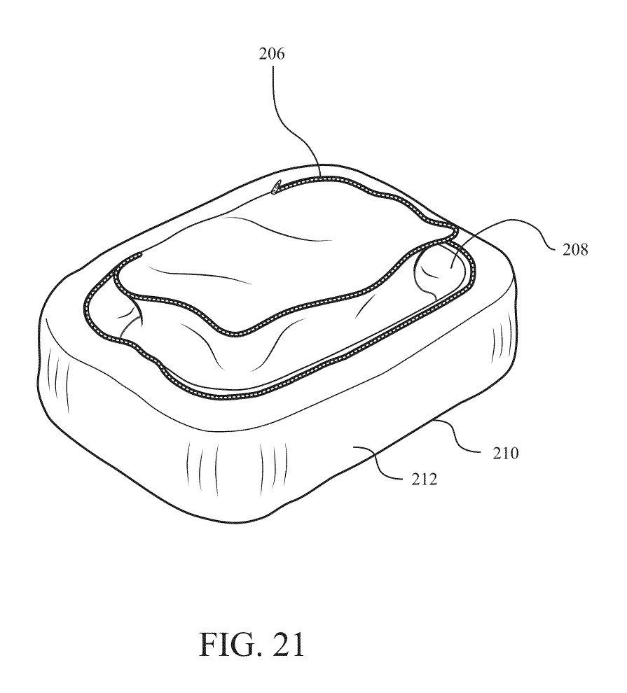

In the illustrated embodiment, the fabric bed frame cover 212 comprises a zipper assembly 206 located on the bottom side of the fabric bed frame cover. The zipper assembly 206 is configured to provide access to an interior 208 of the bed frame cover (shown, for example, in FIGS. 21, 24, and 38).

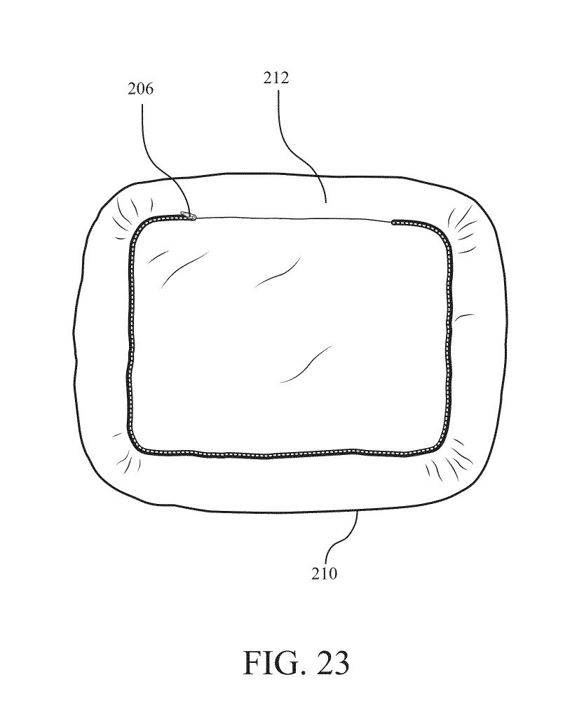

FIG. 23, for instance, is a bottom view of the pet bed 200 and shows the bottom surface of the bed frame cover 212. FIG. 23 further shows an example location of the zipper assembly 206. In the embodiment in FIG. 23, the zipper assembly is generally located along the bottom of the side walls and extends along the bottom of at least three of the side walls. The zipper assembly can have other locations and can also extend more or less than shown in FIG. 23.

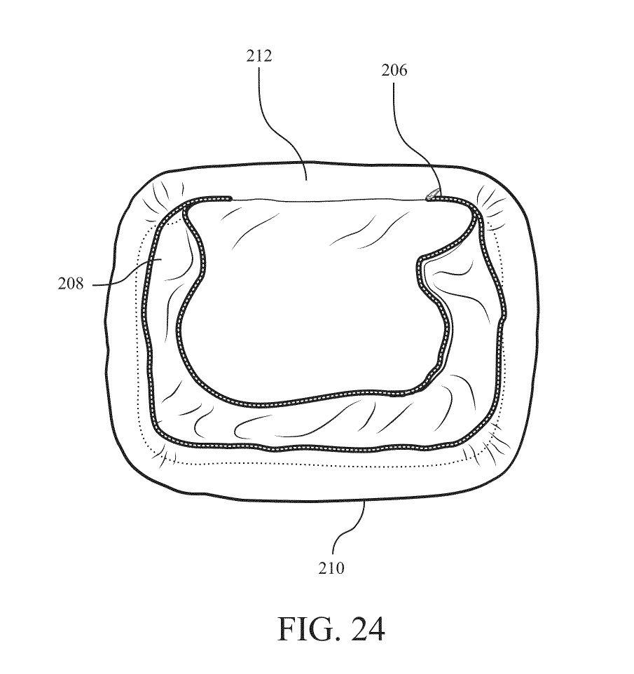

FIG. 24 is a bottom view of the pet bed 200 with the zipper assembly 206 unzipped in order to reveal an interior 208 of the fabric bed frame cover 212. The interior 208 generally forms a channel in the shape of the side walls of the pet bed.

A wide variety of suitable inserts can be provided in the interior 208 in order to provide the structure and support of the pet bed 200. For example, a cushioned insert or pillow formed from a soft foam, from a memory foam, or that is filled with cotton, down, polyester, or other such fiber can be used. In particular embodiments, the insert for the bed frame cover 212 is formed from two or more separate components. The separate components can be individually placed into the interior 208 of the bed frame cover 212 and can have a fastening mechanism at their ends that is used to join the components to one another.

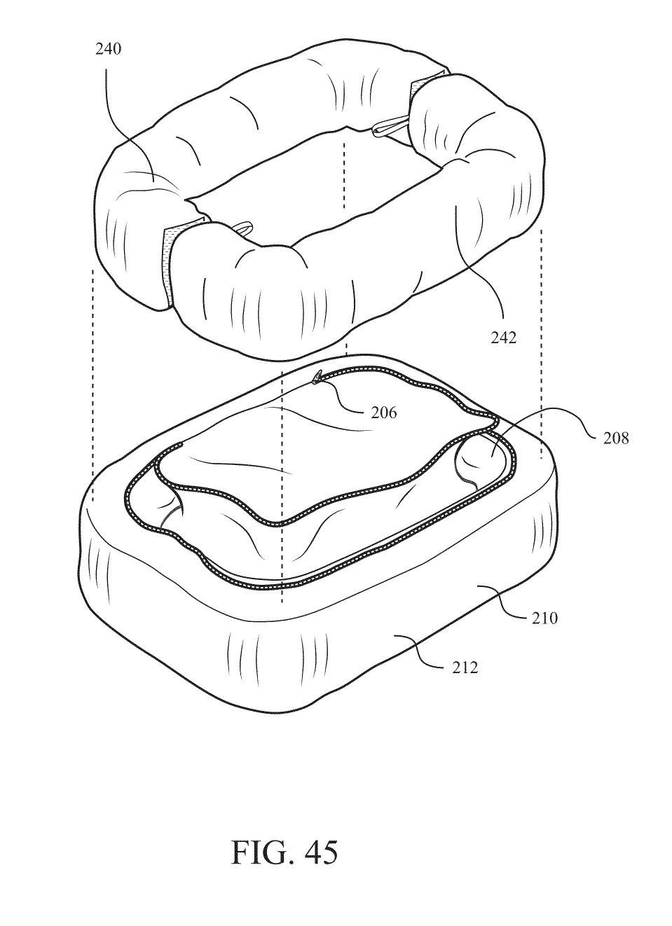

FIG. 45 shows the bed frame cover 212 in combination with one possible bolster pillow system formed from a first bolster pillow component 240 and a second bolster pillow component 242, which is explained in more detail below. In particular, FIG. 45 shows the bolster pillow positioned above the interior channel 208 of the bed frame cover 212 (which for illustrative purposes is shown in the shape the bed frame cover 212 assumes when the bolster pillow system is inserted into the interior 208). FIG. 45 thus shows how the bolster pillow system can be sized to fit within the interior 208 of the bed frame cover 212, and thereby provide structure to the pet bed 200.

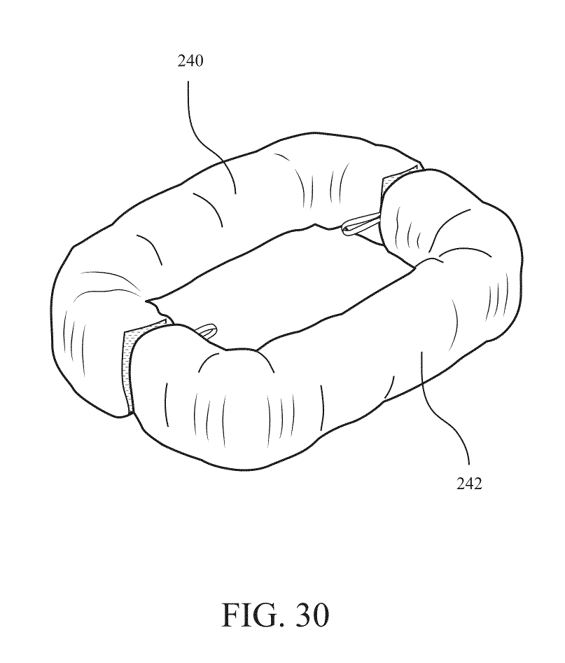

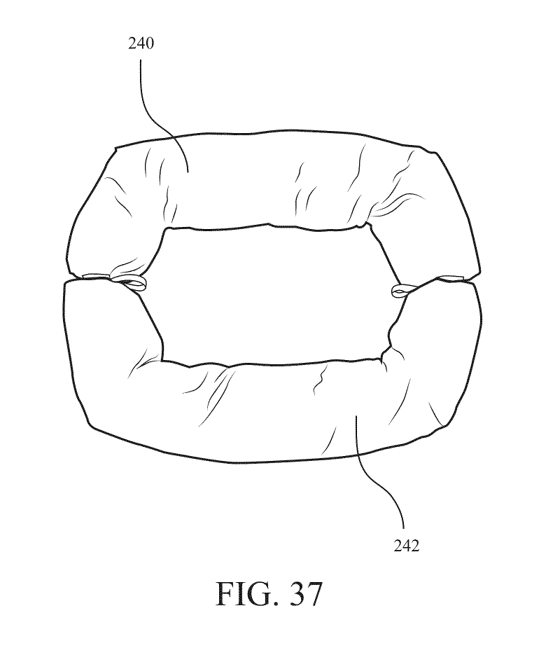

FIG. 30 is a top front perspective view of the example bolster pillow system formed from the first bolster pillow component 240 and the second bolster pillow component 242. FIG. 37 is a top view of the bolster pillow system formed from the first bolster pillow component 240 and the second bolster pillow component 242

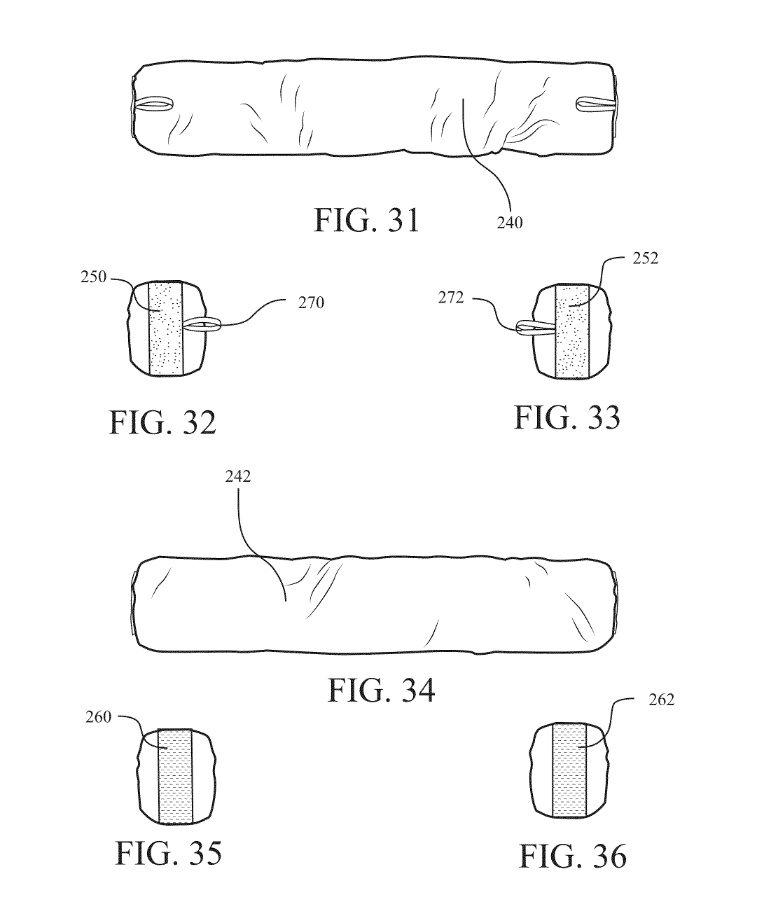

FIGS. 31-33 comprise a front view, a left end view, and right end view, respectively, of the first bolster pillow component 240. FIGS. 34-36 comprise a front view, left end view, and a right end view of the second bolster pillow component 242. As can be seen from FIGS. 31-36, the bolster pillow components 240, 242 can be formed from pillow components that are typically straight, but that can be folded at areas toward their respective ends in order to create the shape of the bed frame 210 (as shown, for example, in FIG. 30 and FIG. 37).

Furthermore, as shown in FIGS. 32-33 and FIGS. 35-36, the ends of the first bolster pillow component can have a first attachment mechanism (such as Velcro hooks 250, 252) whereas the ends of the second bolster pillow components can have a second complementary attachment mechanism that mates with the first attachment mechanism (such as Velcro loops 260, 262). The use of the attachment mechanisms at the ends of the bolster pillow components allow the bolster pillow components to maintain the shape of the bed frame 210 in the absence of external forces or resistance. The ends of one of the bolster components can also have one or more handles to allow the bolster pillows 240, 242 to be easily separated from one another when pulled. For example, and as shown in FIGS. 32 and 33, the first bolster pillow 240 includes handles 270, 272 at its respective ends. The handles 270, 272 can also be used to assist in threading (or inserting) the bolster pillows into the interior 208 of the bed frame cover 212.

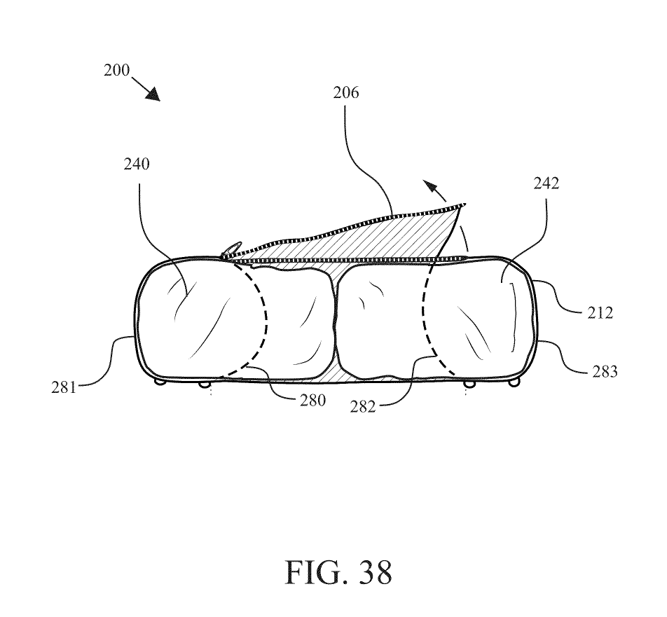

FIG. 38 is a cross-sectional side view of the pet bed 200 showing respective ends of the first and second bolster pillow components 240, 242 being joined to one another within the fabric bed frame cover 212. Also shown is the zipper assembly 206 in an unzipped state. The dashed lines in the interior of the bed frame cover 212 generally show the locations of interior sides 280, 282 of two of the side walls of the pet bed 200. The areas between interior side 280 and exterior side 281 and between interior side 282 and exterior side 283 form the interior channels into which the bolster pillow components 240, 242 are placed.

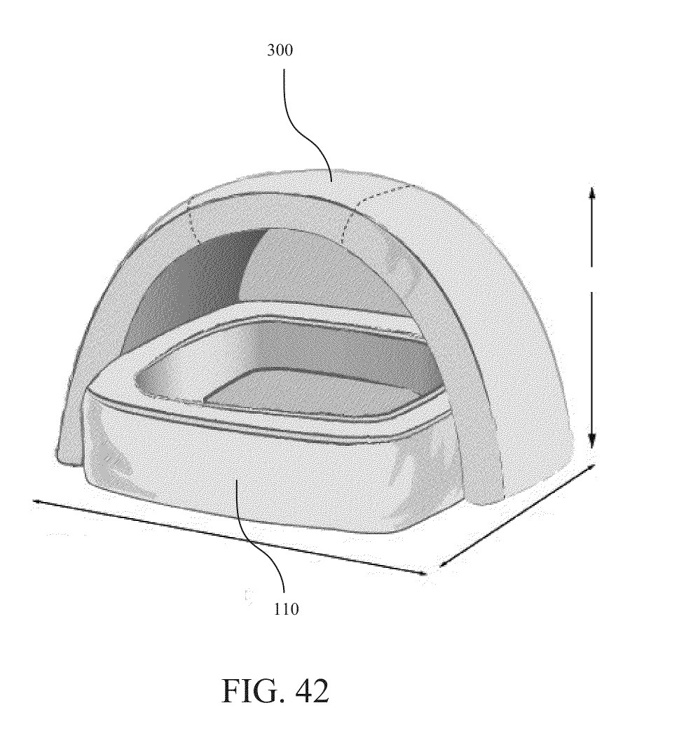

In some embodiments, the modular bed can be placed into a soft canopy “den” to provide a greater feeling of security and comfort to the pet. For example, FIG. 42 shows an exemplary arch-shaped structure 300 that partially encloses the bed frame 110. The arch-shaped structure 300 can be formed from a wide variety of materials, including soft foam, memory foam, a fabric cover that is stuffed with suitable filler, or other such material. The arched structure may also be fabricated without any filling but utilizing fiberglass rods or similar structural components. Further, in the illustrated embodiment, the back side of the arch-shaped structure 300 includes a back wall, thereby creating a partial enclosure (or “den”) for the bed frame 110. The arch-shaped structure 300 creates a secure and comfortable environment in which pets can rest and/or sleep. Furthermore, although a pillow is not shown in FIG. 42, it is to be understood that a pillow (with or without an attached blanket) can be used with the bed frame 110.

In view of the many possible embodiments to which the principles of the disclosed technology may be applied, it should be recognized that the illustrated embodiments are only examples of the disclosed technology and should not be taken as limiting the scope of the invention. For example, any of the bed or dens described or shown herein can be made available in various sizes, colors, fabrics, or patterns. Furthermore, any of the components described herein can be used alone or in different combinations and subcombinations with one another.

For example, the pillow with attached blanket can be used separate from the bed frame (e.g., as an independent bed or as an independent bed for use in the arch-shaped den 300). In such embodiments, for example, the pillow can be considered to form the bed frame (e.g., a cushioned bed frame). The bed frame can have one or more side walls, or no side walls at all. For example, in one embodiment, the modular bed system comprises a cushioned bed frame having a top surface and outward-facing side edges, and a blanket fastened to at least a central portion of the top surface of the bed frame such that a majority of the outward-facing edges of the blanket are free and unaffixed to the bed frame. In certain implementations, the blanket can be sized to cover at least a majority of the top surface of the pillow and to have outward-facing edges that extend beyond at least some of the outward-facing side edges of the bed frame. As with other embodiments disclosed herein and described above, the blanket can be fastened to the cushioned bed frame using an “X-shaped” or “plus-shaped” stitching pattern that is centered on the top surface of the cushioned bed frame and thereby creates a plurality of ruffle regions. The cushioned bed frame can have a variety of shapes, such as square, rectangular, circular, or oval shape. Furthermore, and as explained above, the blanket can be affixed to the cushioned bed frame in a manner that allows a pet or other user using the bed to freely move the unaffixed portion of the blanket so that the blanket is not smooth. As described above with respect to FIGS. 46-49, the blanket can be formed from two or more fabric panels.

Still further, the pillow with attached blanket can be affixed or selectively affixed to the enclosure of the bed frame. For example, the pillow and blanket can be stitched or otherwise connected to the interior of the bed frame enclosure (e.g., using any of the fastening techniques described above) or can be selectively affixed to the interior of the bed frame enclosure via Velcro, a zipper mechanism, a button mechanism, or any other selective fastener (e.g., using any of the selective fasteners described herein).

It should also be understood that the embodiments disclosed herein are not limited for use by pets but can be adapted and sized for other potential users. For instance, in certain implementations, the bed system is adapted for use by newborns and infants, providing them with an environment in which they can play and arrange the blanket without the blanket being separated from the pillow or bed frame.

Additional information about embodiments of the disclosed technology is described in U.S. Provisional Application No. 61/767,745, filed on Feb. 21, 2013, and entitled “MODULAR BEDS AND ENVIRONMENTS FOR PETS”, and U.S. Provisional Application No. 61/840,396, filed on Jun. 27, 2013, and entitled “MODULAR BEDS AND ENVIRONMENTS FOR PETS”, which are both hereby incorporated herein by reference.

I therefore claim as my invention all that comes within the scope and spirit of the following claims and their equivalents.

What is claimed is:

1. A modular bed system, comprising:
a bed frame comprising one or more side walls that surround a central cavity of the bed frame;
a pillow sized to fit within the central cavity of the bed frame; and
a blanket affixed to the pillow in a manner that allows a majority of the perimeter edges of the blanket to be free of the pillow.

2. The modular bed of claim 1, wherein the bed frame and the pillow have a square, rectangular, circular, or oval shape.

3. The modular bed of claim 1, wherein the blanket is oversized relative to the pillow such that the blanket covers the top surface of the pillow and has perimeter edges that extend beyond the perimeter edges of the pillow.

4. The modular bed of claim 1, wherein the blanket has a generally circular shape whereas the pillow has either a square or rectangular shape.

5. The modular bed of claim 1, wherein the blanket is affixed to the pillow in a manner that allows a pet or other user using the bed to freely move and ruffle the blanket except at the points at which the blanket is affixed to the pillow.

6. The modular bed of claim 1, wherein the blanket is formed from two or more fabric panels.

7. The modular bed of claim 1, wherein the bed frame is formed from a fabric bed frame cover and a bed frame cushion located in the interior of the fabric bed frame cover, the bed frame cushion being removable from the bed frame cover.

8. The modular bed of claim 7, wherein the bed frame cushion is formed from two or more cushion components detachable from one another.

9. The modular bed of claim 8, wherein the two or more cushion components comprise a first bolster pillow and a second bolster pillow, the first bolster pillow and the second bolster pillow being bendable.

10. The modular bed of claim 9, wherein the ends of the first bolster pillow and the second bolster pillow include an attachment mechanism such that the ends of the first bolster pillow are attachable to the ends of the second bolster when the first bolster pillow and the second bolster pillows are bent into the shape of the bed frame.

11. A modular bed system, comprising:
a pillow having a top surface, a bottom surface, and one or more outward-facing side edges; and
a blanket fastened to at least a central portion of the top surface of the pillow such that a majority of the outward-facing edges of the blanket are free and unaffixed to the pillow, the blanket being sized to cover at least a majority of the top surface of the pillow and to have outward-facing edges that extend beyond at least some of the outward-facing side edges of the pillow.

12. The modular bed system of claim 11, further comprising:
a cushioned bed frame having a central area surrounded by one or more side walls, the central area being complementary in shape to the pillow and being sized to receive the pillow.

13. The modular bed system of claim 12, wherein the one or more side walls have a top surface that extends around a perimeter of the cushioned bed frame, and wherein the blanket is sized to at least partially cover the top surface of the side walls when the pillow is placed in the central area of the cushioned bed frame.

14. The modular bed system of claim 11, wherein the blanket is fastened to the pillow using an “X-shaped” or “plus-shaped” stitching pattern that is centered on the top surface of the pillow and thereby creates a plurality of ruffle regions.

15. The modular bed system of claim 11, wherein the pillow has a square, rectangular, circular, or oval shape.

16. The bed system of claim 11, wherein the blanket is affixed to the pillow in a manner that allows a pet or other user using the bed to freely move the unaffixed portion of the blanket so that the blanket is not smooth.

17. The bed system of claim 11, wherein the blanket is formed from two or more fabric panels.

18. A modular bed system, comprising:
a cushioned bed frame comprising one or more side walls that surround an central area, the cushioned bed frame having a bottom surface, the cushioned bed frame being formed from:
a fabric bed frame cover, the bed frame cover including a zipper assembly located on the bottom surface of the fabric bed frame cover, the zipper assembly being configured to provide selective access to an interior of the bed frame cover; and
a bed frame cushion positioned in the interior of the fabric bed frame cover, the bed frame cushion providing the structure of the one or more side walls, the bed frame cushion being removable from the fabric bed frame cover via the zipper assembly of the fabric bed frame cover.

19. The modular bed system of claim 18, wherein the bed frame cushion is formed from two or more cushion components.

20. The modular bed system of claim 19, wherein the two or more cushion components consist of a first bolster pillow and a second bolster pillow.

21. The modular bed system of claim 20, wherein the first bolster pillow and the second bolster pillow are bendable and wherein the ends of the first bolster pillow are attachable to the ends of the second bolster via an attachment mechanism when the first bolster pillow and the second bolster pillows are bent into the shape of the bed frame and the ends of the first bolster pillow are abutted to the ends of the second bolster pillow.

22. The modular bed system of claim 18, further comprising:
a pillow having a shape that is complementary to the central area of the cushioned bed frame, the pillow having a top surface, a bottom surface, and one or more outward-facing side edges; and
a blanket fastened to at least a central portion of the top surface of the pillow such that all outward-facing edges of the blanket are free and unaffixed to the pillow, the blanket being sized to cover the top surface of the pillow and to have outward-facing edges that extend beyond the outward-facing side edges of the pillow.

23. The modular bed system of claim 22, wherein the blanket is formed from two or more blanket panels.

24. A modular bed system, comprising:
a cushioned bed frame having a top surface and outward-facing side edges; and
a blanket fastened to at least a central portion of the top surface of the bed frame such that a majority of the outward-facing edges of the blanket are free and unaffixed to the bed frame, the blanket being sized to cover at least a majority of the top surface of the pillow and to have outward-facing edges that extend beyond at least some of the outward-facing side edges of the bed frame.

25. The modular bed system of claim 24, wherein the blanket is fastened to the cushioned bed frame using an “X-shaped” or “plus-shaped” stitching pattern that is centered on the top surface of the cushioned bed frame and thereby creates a plurality of ruffle regions.

26. The modular bed system of claim 24, wherein the cushioned bed frame has a square, rectangular, circular, or oval shape.

27. The bed system of claim 24, wherein the blanket is affixed to the cushioned bed frame in a manner that allows a pet or other user using the bed to freely move the unaffixed portion of the blanket so that the blanket is not smooth.

28. The bed system of claim 24, wherein the blanket is formed from two or more fabric panels.
